(19) United States
(12) Patent Application Publication
(10) Pub. No.: US 2025/0062469 A1
(43) Pub. Date: Feb. 20, 2025

(54) Drive Battery for a Motor Vehicle, and Motor Vehicle Comprising Such a Drive Battery

(71) Applicant: Bayerische Motoren Werke Aktiengesellschaft, Muenchen (DE)

(72) Inventors: Georg VOELKER, Unterschleissheim (DE); Matthias WAGNER, Muenchen (DE)

(21) Appl. No.: 18/721,404

(22) PCT Filed: Feb. 15, 2023
(86) PCT No.: PCT/EP2023/053759

§ 371 Date: Jun. 18, 2024

(30) Foreign Application Priority Data
Feb. 22, 2022 (DE) 10 2022 104 178.6

(51) Int. Cl. H01M 50/242; H01M 50/249; H01M 50/289

(52) U.S. Cl. CPC H01M 50/242; H01M 50/249; H01M 50/289; H01M 2220/20

(57) ABSTRACT

A drive battery for a motor vehicle has a drive battery housing with a bottom wall and a top wall, a battery cell layer arranged between the bottom wall and the top wall, and a plurality of battery cells and a battery cell contacting system. A support layer, which according to its function can also be called a deformation layer or spacer layer, is arranged between the battery cell layer and the bottom wall, in order to protect the battery layer in the event of a collision of the bottom wall. The support layer is designed as a carrier for the battery cell contacting system.

### BACKGROUND AND SUMMARY

The present invention relates to a drive battery for a motor vehicle and to a motor vehicle comprising such a drive battery.

A motor vehicle with an electric drive usually has a drive battery that has a drive battery housing in which several battery modules with battery cells, an electrical/electronics system and a cooling system are mounted. The drive battery housing is in turn mounted underneath a floor assembly on a vehicle body. The known drive battery housing is made of aluminum, for example, and has side supports, a cover and a base. The side supports are designed, for example, as extruded profiles or cast parts. Additional longitudinal members and cross members may also be provided in the battery housing to give the drive battery a certain rigidity and collision resistance.

As presented in DE 10 2017 223 407 A1, a known drive battery housing has longitudinal members and a plurality of cross members extending between the longitudinal members. Furthermore, the drive battery housing has an upper wall and a lower wall, each of which is connected to at least one outer support structure, i.e. the outer longitudinal members and the outer cross members. The longitudinal members and the cross members are made of extruded profiles. The drive battery housing is mounted underneath a body floor.

It is the object of the present invention to create a drive battery or a motor vehicle comprising such a drive battery, wherein the drive battery is of a simpler design and is easier to manufacture.

This object is achieved by a drive battery or a motor vehicle comprising such a drive battery, which have the features of the independent claims. Advantageous embodiments of the invention are described in the dependent claims.

According to the invention, a drive battery for a motor vehicle comprising a drive battery housing which has a bottom wall and a top wall has a battery cell layer which is arranged between the bottom wall and the top wall and has a plurality of battery cells, and a battery cell contacting system. A support layer, which can also be called a deformation layer or spacer layer depending on its function, is arranged between the battery cell layer and the bottom wall to protect the battery cell layer in the event of a collision with the bottom wall. The support layer is designed as a carrier for the battery cell contacting system.

By connecting the battery cell contacting system to the support layer, the support layer can be handled as one component with the battery cell contacting system during drive battery production, which simplifies production.

The battery cell contacting system is preferably adhesively bonded to the support layer.

This enables a durable and good connection between the battery cell contacting system and the support layer during operation of the drive battery, but also during handling in the manufacturing process.

Alternatively or additionally, the battery cell contacting system can be interlockingly connected to the support layer. An interlocking connection can be made, for example, by a clip connection or by heat caulking projections of the support layer, which is made of plastic in particular, in relation to the battery cell contacting system.

Furthermore, the battery cell contacting system can be press-fitted to the support layer.

This also provides a reliable and durable connection between the battery cell contacting system and the support layer during operation of the drive battery, but also during handling in the manufacturing process.

Furthermore, the battery cell contacting system can be overmolded by the support layer. The battery cell contacting system can also be encapsulated in foam by the support layer.

In both cases, the battery cell contacting system can be easily integrated into the support layer interlockingly during the manufacture of the support layer. For this purpose, the battery cell contacting system is inserted into the corresponding tool during the manufacture of the support layer.

Advantageously, the battery cell contacting system is conductively connected, in particular soldered or welded, to the contacts of each battery cell.

Accordingly, the unit or the layer consisting of the support layer and the battery cell contacting system is positioned on the battery cell layer and then the conductive connection is established. By attaching the battery cell contacting system to the support layer, it is much easier to position the battery cell contacting system in order to connect it to the battery cells.

The support layer can consist of a plastics injection molded part or a press-molded part, e.g. manufactured using an SMC (sheet molding compound) process, or a molded foam part, e.g. made of expanded polypropylene (EPP).

The battery cell contacting system can consist of aluminum punched sheet(s).

According to a preferred development, the bottom wall at least partially forms an underbody of the motor vehicle.

This means that there is no further layer below the bottom wall. If the underbody of the vehicle comes into contact with the ground or with an object on the ground, the ground or the object makes direct contact with the bottom wall. In other words, there is no further component of the vehicle underneath the bottom. A collision force caused by the road surface or the object on the road surface is thus transferred from the bottom wall to the spacer layer, which in turn is supported on the battery cell layer. This allows the bottom wall and the spacer layer to deform advantageously while dissipating collision energy.

Furthermore, the battery cell layer can be designed with a plurality of battery cells arranged vertically and next to each other, wherein each battery cell can consist of a battery cell housing and a cell coil, which is accommodated in the battery cell housing. An upper end face of the battery cells or the battery cell housing is preferably adhesively bonded to the top wall and a lower end face of the battery cells or the battery cell housing is preferably bonded to the support layer.

The multiplicity of battery cell housings thus form a multi-chamber structure, which is similar to a honeycomb structure and significantly increases the bending rigidity and torsional rigidity of the drive battery by adhesively bonding it to the neighboring layers.

The aforementioned battery cell housings can consist of a battery cell housing shell and battery cell housing covers. The support layer can be designed here to be congruent with the battery cell housing shells, wherein the support layer in particular has a continuous support surface for the battery cell housing shells.

According to a preferred development, the support layer is also adhesively bonded to the bottom wall by means of a bottom adhesive layer and/or is adhesively bonded to the battery cell layer by means of a top adhesive layer. The battery cell layer can also be adhesively bonded to the top wall by means of an uppermost adhesive layer.

Due to the sandwich-like adhesively bonding of the top wall, battery cell layer, support layer and bottom wall, the drive battery has a high torsional and bending rigidity overall, so that no further support structure is required within the drive battery. All layers of the drive battery contribute to the rigidity and strength of the drive battery. The drive battery is designed for installation in the vehicle in such a way that the top wall is at the top and the bottom wall is at the bottom.

The support layer is preferably structurally effective and increases the rigidity and strength of the drive battery.

Advantageously, the battery cells of the drive battery are not grouped into several battery cell modules, as described above in relation to the prior art. The drive battery is thus designed to be module-free or battery-cell-module-free.

The above-mentioned developments of the invention can be combined with each other as far as possible and appropriate.

### BRIEF DESCRIPTION OF THE DRAWINGS

FIG. 1 is a highly schematic sectional view of a drive battery according to an exemplary embodiment of the present invention.

FIG. 2 schematically shows a perspective view of a part of a support layer with a battery cell contacting system of the drive battery according to the exemplary embodiment of the present invention.

FIG. 3 schematically shows a perspective view of a motor vehicle with a body and a drive battery before mounting the drive battery on the body according to the exemplary embodiment of the present invention.

### DETAILED DESCRIPTION OF THE DRAWINGS

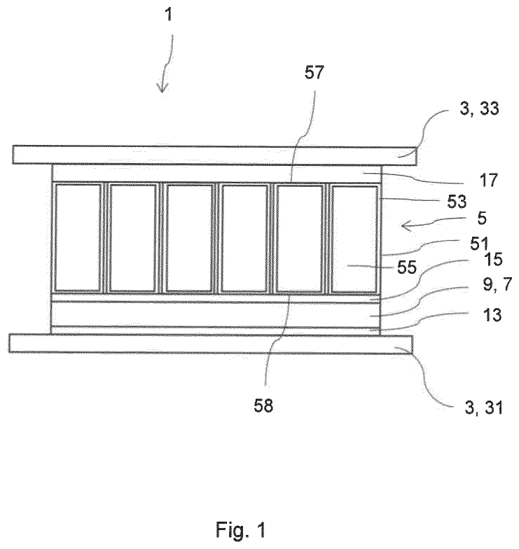

The following is a description of an exemplary embodiment of the present invention with reference to FIGS. 1 to 3.

In FIG. 1, a drive battery 1 according to the exemplary embodiment of the present invention is shown very schematically in a sectional view. The drive battery 1 is designed for mounting on a body of a motor vehicle, in particular a passenger car. The drive battery 1 is a so-called high-voltage storage device for driving an electric drive motor of the passenger car. The drive battery 1 has a sandwich-like structure consisting of several layers. Starting from the top, the drive battery 1 has a top wall 33 as part of a drive battery housing 3. The top wall 33 is connected to the top side of a battery cell layer 5 via an upper adhesive layer 17. Furthermore, the underside of the battery cell layer 5 is connected to a support layer 9 via a lower adhesive layer 15. The underside of the support layer 9 is in turn connected to a bottom wall 31 of the drive battery housing 3 via a further adhesive layer 13.

The battery cell layer 5 consists of a plurality of battery cells 51. Each battery cell 51 in turn consists of a battery cell housing 53 made of aluminum or steel, in which a cell winding 55 is accommodated. The battery cells 51 are so-called round cells with a circular cylindrical shape. The battery cells 51 are arranged on edge, i.e. vertically, in the battery cell layer 5, so that they adjoin each other with their lateral surfaces. The upper end faces of the battery cells 51 are each connected to the adhesive layer 17 and thus to the top wall 33. The lower end faces of the battery cells 51 are each connected to the adhesive layer 15 and thus to the support layer 9.

Both poles 59 of the battery cells 51 are located on the lower end face of each battery cell 51. Degassing openings are also formed on the lower end face of the battery cells 51. Complementary to the degassing openings of the battery cells 51, recesses or degassing spaces are formed in the support layer 9. Accordingly, the adhesive layer 15 also has recesses. The recesses are suitably connected to each other via degassing channels, so that gas escaping from a battery cell 51 can be discharged via the degassing channels of the support layer 9.

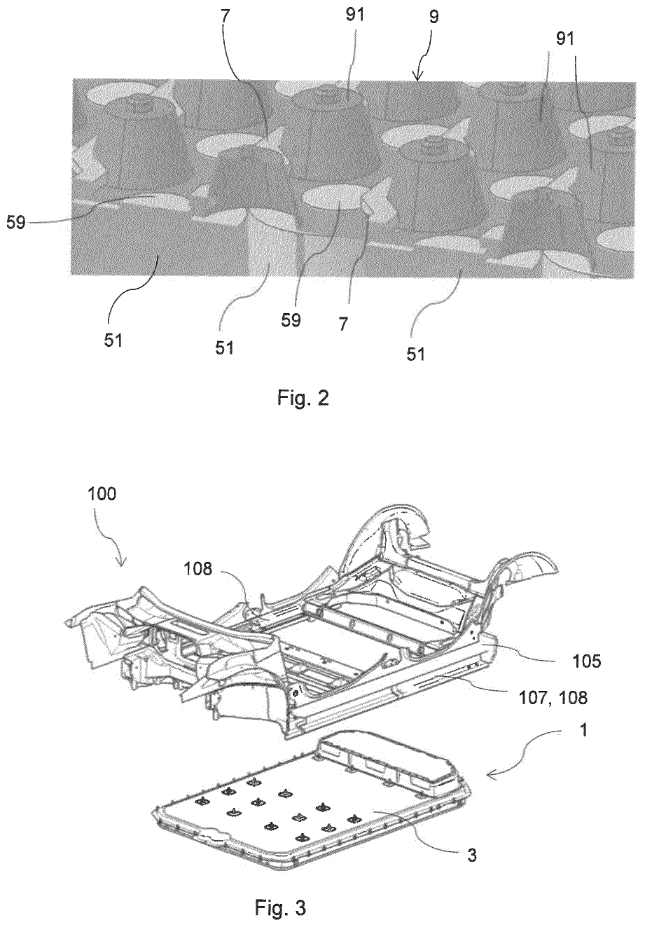

FIG. 2 shows a perspective view of the support layer 9 with a battery cell contacting system 7. The support layer 9 is a plastics injection-molded part and has a plate-shaped main body on which a plurality of cup-shaped projections 91 are formed. The support layer 9, i.e., in particular the cup-shaped projections 91, is deformable. In the event of a ground collision of the drive battery 1 installed in the motor vehicle, the bottom wall 31 may be deformed together with the support layer 9 and can thus absorb collision energy by deformation to protect the battery cell layer 5. The battery cell contacting system 7 consists of a large number of stamped aluminum conductor tracks, which are interlockingly connected to the support layer 9 by means of a clip connection. The conductor tracks of the battery cell contacting system 7 are conductively connected to the poles 59 of the battery cells 51.

During manufacture, the support layer 9 and the battery cell contacting system 7 are first clipped together. Then, the assembly consisting of the support layer 9 and the battery cell contacting system 7 is adhesively bonded to the battery cell layer 5. Battery cell contacts of the battery cell contacting system 7 are then connected to the poles 59 by soldering, for example. The prior connection of the support layer 9 and the battery cell contacting system 7 simplifies the handling of the battery cell contacting system 7, as it is suitably stabilized by the support layer 9 and is already in the correct position due to the interlocking connection.

FIG. 3 shows the state before the drive battery 1 is installed on a body 100. The body 100 is not shown completely in FIG. 1, but substantially only a floor assembly 105 of the body 100. The body 100 or the floor assembly 105 has a left side sill 107 and a right side sill 108, i.e., longitudinal members. The drive battery 1 has the drive battery housing 3 described above, which has substantially the same height over its entire extent—with the exception of an additional housing attached in the rear region of the drive battery 1. The battery cell layer 5 is accommodated in the drive battery housing 3. A power electronics unit, for example, is housed in the additional housing. The drive battery 1 is mounted from below on the floor assembly 105 by means of screw connections and, if necessary, additionally by adhesive connections.

1.-11. (canceled)

12. A drive battery for a motor vehicle, comprising:
a drive battery housing comprising a bottom wall and a top wall;
a battery cell layer arranged between the bottom wall and the top wall and comprising a plurality of battery cells and a battery cell contacting system; and
a support layer arranged between the battery cell layer and the bottom wall to protect the battery cell layer in an event of a collision with the bottom wall,
wherein the support layer is configured as a carrier for the battery cell contacting system.

13. The drive battery according to claim 12, wherein the battery cell contacting system is adhesively bonded to the support layer.

14. The drive battery according to claim 12, wherein the battery cell contacting system is interlockingly connected to the support layer.

15. The drive battery according to claim 14, wherein the interlocking connection is a clipped and/or heat caulked connection.

16. The drive battery according to claim 12, wherein the battery cell contacting system is press-fit to the support layer.

17. The drive battery according to claim 12, wherein the battery cell contacting system is overmolded or encapsulated in foam by the support layer.

18. The drive battery according to claim 12, wherein the battery cell contacting system is conductively connected to contacts of each battery cell.

19. The drive battery according to claim 18, wherein the conductive connection is a soldered or welded connection.

20. The drive battery according to claim 12, wherein the support layer is a plastics injection-molded part or a press-molded part or a molded foam part.

21. The drive battery according to claim 12, wherein the bottom wall at least partially forms an underbody of the motor vehicle.

22. The drive battery according to claim 12, wherein the battery cell layer is formed with a plurality of battery cells arranged vertically and side-by-side.

23. The drive battery according to claim 12, wherein
the support layer is adhesively bonded to the bottom wall by way of a lowermost adhesive layer and/or is adhesively bonded to the battery cell layer by way of an upper adhesive layer, and
the battery cell layer is adhesively bonded to the top wall by way of an uppermost adhesive layer.

24. A motor vehicle, comprising:
a vehicle body; and
a drive battery comprising
a drive battery housing having a bottom wall and a top wall;
a battery cell layer arranged between the bottom wall and the top wall and comprising a plurality of battery cells and a battery cell contacting system; and
a support layer arranged between the battery cell layer and the bottom wall to protect the battery cell layer in an event of a collision with the bottom wall,
wherein the support layer is configured as a carrier for the battery cell contacting system.
